(19) United States
(12) Patent Application Publication
(10) Pub. No.: US 2014/0149491 A1
(43) Pub. Date: May 29, 2014

(54) Real-Time Affinity- and Proximity-Based Monitoring and Control System and Method and Correlation Engine Therefor

(71) Applicants: Christian Rivadalla, Scottsdale, AZ (US); Christian Rivadalla, JR., Scottsdale, AZ (US)

(72) Inventors: Christian Rivadalla, Scottsdale, AZ (US); Christian Rivadalla, JR., Scottsdale, AZ (US)

(21) Appl. No.: 13/687,671

(22) Filed: Nov. 28, 2012

(51) Int. Cl. H04L 29/06

(52) U.S. Cl. CPC H04L 67/42
USPC 709/203

(57) ABSTRACT

A real-time mobile device monitoring and control system includes two or more mobile devices configured to run application software, the software configured to enable each of the two or more devices in real time to communicate their respective geo-location data to a web-based server; a database configured to affiliate the two or more mobile devices with their respective registered owners, the database storing the two or more registered owners' names and real-time geo-location data, the database further storing the two or more registered owners' demographic data including personal attributes, the demographic data capable of being updated in real time by a web-based server; and a web-based server configured to respond periodically to demographic and geographic information about the two or more registered owners of the two or more mobile devices by storing the same in the database in real time. A correlation engine therefor and another system also are disclosed.

### FIELD OF THE INVENTION

The invention relates generally to the field of mobile device user services. More particularly, the invention relates to monitoring and controlling mobile devices in real-time.

### BACKGROUND OF THE INVENTION

Geo-location of mobile devices such as mobile phones, smart phones or tablet computers conventionally is based on the use of a global positioning system (GPS). It is possible now to determine the location of a mobile device to within a block's or even a few meters' or yards' precision. A mobile device provides its user with information such as directions or on-line purchase opportunities via one or more web servers that are in communication with the mobile device. A mobile device also provides e-mail and social networking services to its user. Application software (referred to herein as an ‘app’) that is loaded on a mobile device also can provide web browsing, game playing, and other services via the web. One such mobile device currently in use to provide such services is generally referred to as a smart phone.

Web service providers conventionally provide many personal and business services to a user of a personal or tablet computer with web access. Such services might include a business address and phone number or map thereto, a dating service, an announcement of a public or private event, a public service announcement or weather warning, or a business advertisement that targets the user based upon that user's web-browsing history, a chat room for social interaction on a current event, etc.

### BRIEF DESCRIPTION OF THE DRAWINGS

FIG. 1 is a system block diagram of the system, in accordance with one embodiment of the invention.

FIG. 2 is a process flow diagram illustrating a user sign-in part of the method in accordance with one embodiment of the invention.

FIG. 3 is a process flow diagram illustrating a user add/edit attributes part of the method in accordance with one embodiment of the invention.

FIG. 4 is a process flow diagram illustrating a find users part of the method including the geographic and demographic data-producing step in accordance with one embodiment of the invention.

FIG. 5 is a process flow diagram illustrating a user compatibility part of the method including the geographic and demographic weighted averaging- and correlation index-producing step in accordance with one embodiment of the invention.

FIG. 6 is a process flow diagram illustrating a find business part of the method in accordance with another embodiment of the invention.

FIG. 7 is a system block diagram of the system, in accordance with another embodiment of the invention.

FIG. 8 is a schematic block diagram of an affinity-and-proximity correlation engine, in accordance with one embodiment of the invention.

FIGS. 9A and 9B are graphic illustrations representing screen grabs from the user device that inform the user of one or more businesses and/or one or more other users' proximity and compatibility or affinity with the primary user in alternatively graphic (e.g. map) and/or tabular (e.g. list) form, respectively.

### DETAILED DESCRIPTION OF THE PREFERRED EMBODIMENTS

### Definitions

“Affinity”, as used herein, is intended to refer broadly to an inclination towards or compatibility with, whether conscious or unconscious, whether knowing or unknowing, whether acknowledged or not. Thus a user may be entirely unaware of another user's or business's characteristics or attributes but may still have a determined affinity for that other user or business, as defined herein, by virtue of one or more criteria of each that is compatible with one or more criteria of the other. “Translation”, as used herein, refers to a linguistic mapping of one or more attributes such as immutable characteristics (“DNA”), current likes, current dislikes, and current needs to synonyms therefor. For example, “the bomb” might mean “great”, and thus might be “translated” thereto by a synonym-mapping algorithm to ensure that demographic data, e.g. personal attributes, can be properly compared and contrasted as between two users or as between a single user and a business. Such can be performed in accordance with any suitable technique, such as by the use of a relational database or a simple look-up table or so-called ‘map’.

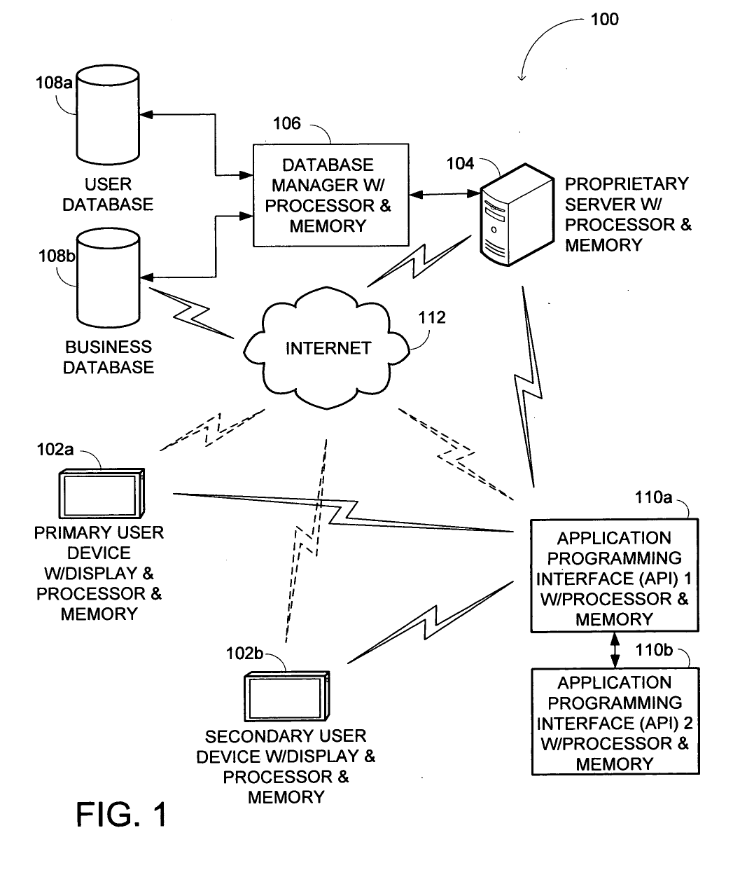

FIG. 1 is a system block diagram of the system including an affinity-and-proximity correlation engine, in accordance with one embodiment of the invention. As may be seen, system 100 includes a primary and preferably portable user device 102a preferably with a graphic display, and a secondary and preferably portable user device 102b also preferably with a graphic display. System 100 further includes one or more instantiations of a NEULT™ proprietary server 104 operatively coupled with a database manager 106. Database manager 106 is operatively coupled with a user database 108a and a business database 108b (that may also be coupled to Internet 112, as indicated, for real-time updates. Server 104 is also operatively connected with a first application programming interface (API) 110a, which in turn is operatively coupled with a second API 120b. User devices 102a and 102b and server 104 are operatively coupled with a world-wide web, e.g. the Internet 112.

NEULT™ is a trademark owned by SoftPoint LLC, assignee of the present invention. World-wide trademark rights are reserved.

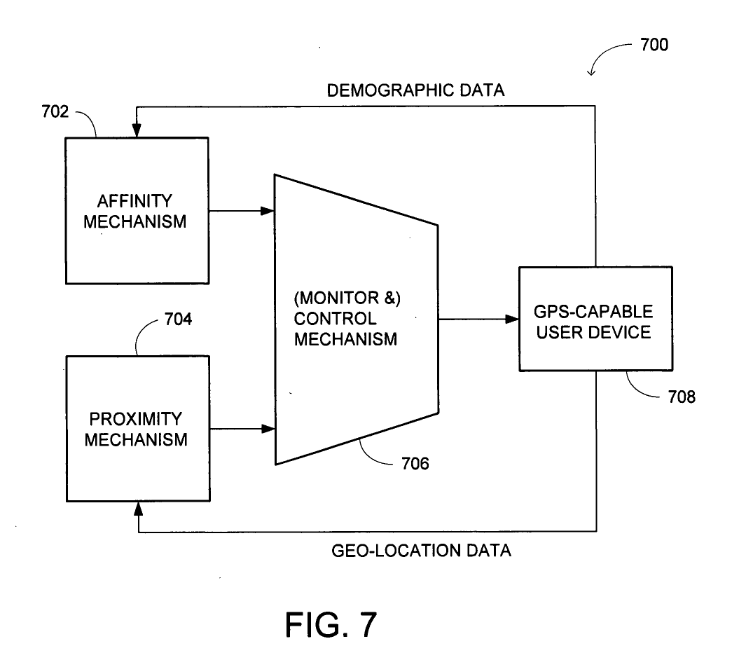

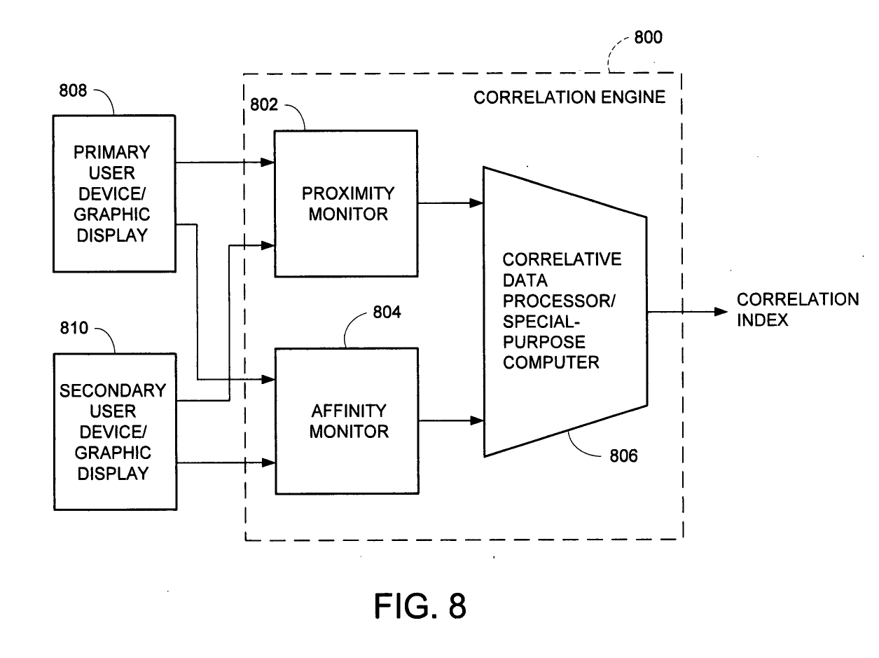

Those of skill in the art will appreciate that user devices 102a and 102b are operatively coupled with APIs 110a and 110b, whether directly (solid lines) or via Internet 112 (dashed lines). Those of skill in the art will also appreciate that user devices 102a and 102b, server 104, database manager 106, and APIs 110a and 110b include a processor and a memory containing application program instructions executable by the processor, thus rendering each a machine configured to perform at least the functions described and illustrated herein. Thus, the processor and memory containing the application programming instructions configured when executed to perform such described and illustrated functions are referred to herein as one or more so-called ‘apps’. Those of skill in the art will appreciate that system 100 embodies an affinity mechanism, a proximity mechanism, and a control mechanism, as will be described in detail below by reference to FIG. 7. Those of skill in the art also will appreciate that system 100 also embodies a correlation engine, as will be described in detail below by reference to FIG. 8.

Those of skill in the art will appreciate that users of their user devices may be required to the download app, and to subscribe or enroll in order to obtain the many advantages of the invention. Such may be conventionally done by requiring the user to enter a user identification (ID) and a password that collectively uniquely identify each user from every other user of the invented system. The user IDs and passwords may be stored in a secure, e.g. proprietary, database that forms a part of the invention. Such a user ID and password database may be the same, for example, as database 108a or 108b, or may instead be a separate database (not shown in FIG. 1, for the sake of brevity). Such a subscription may use standard encryption techniques to preserve the user-entered data securely against piracy or unauthorized use, as is known.

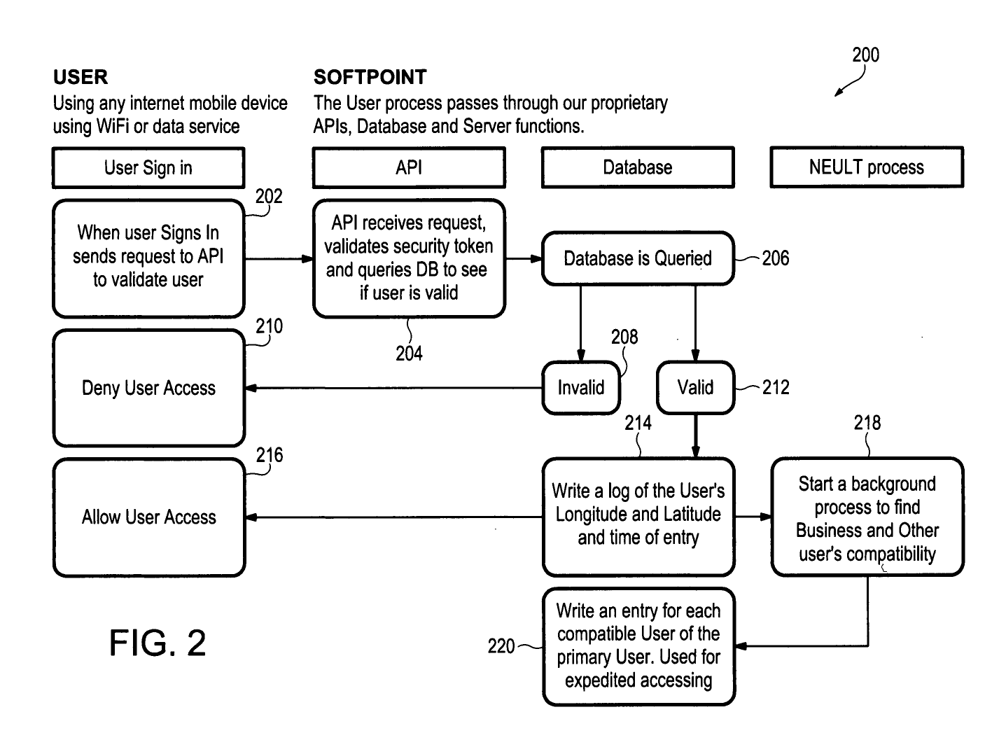

FIG. 2 is a process flow diagram illustrating a user sign-in part of the method in accordance with one embodiment of the invention. As may be seen, user sign-in process 200 begins at 202 when a user device such as user device 102a signs in and app sends a request to API 110a in an attempt to validate the user. At 204, API 110a receives the request, validates the security token, and queries database manager 106 to determine whether the user is valid. At 206, database manager 106 is queried. If the user is invalid at 208, then database manager 106 sends an invalidity signal to user device 102a, and access by the invalid user of user device 102a is denied at 210. If the user is determined by database manager 106 to be valid at 212, then at 214 the database manager writes or creates a log of the valid user's longitude and latitude and time of entry and sends a validity signal to user device 102a. Access by the valid user of the user device is allowed by user device 102a at 216.

At 218, database manager 106 signals proprietary NEULT™ server 104 to start a background process to find one or more compatible or affinitive businesses and other users. Finally with respect to user sign-in process 200, proprietary NEULT™ server 104 signals database manager 106 at 220 to create or write an entry for each of any businesses and/or users that have been determined to be compatible with or affinitive to the primary user. Those of skill in the art will appreciate that the creating or writing steps 214 and 220 reduce system latency for later processes by the pre-calculation and storage by database manager 106 of user proximity and affinity data relative to one or more compatible businesses and/or users. This makes invented system 100 responsive in real-time to changing user device input data, whether the change is one of longitude or latitude (i.e. geographic or geo-location data that are later used to determine the user's proximity to other businesses and/or users) or of preference or need (i.e. demographic data that are later used to determine the user's compatibility or affinity with businesses and/or other users).

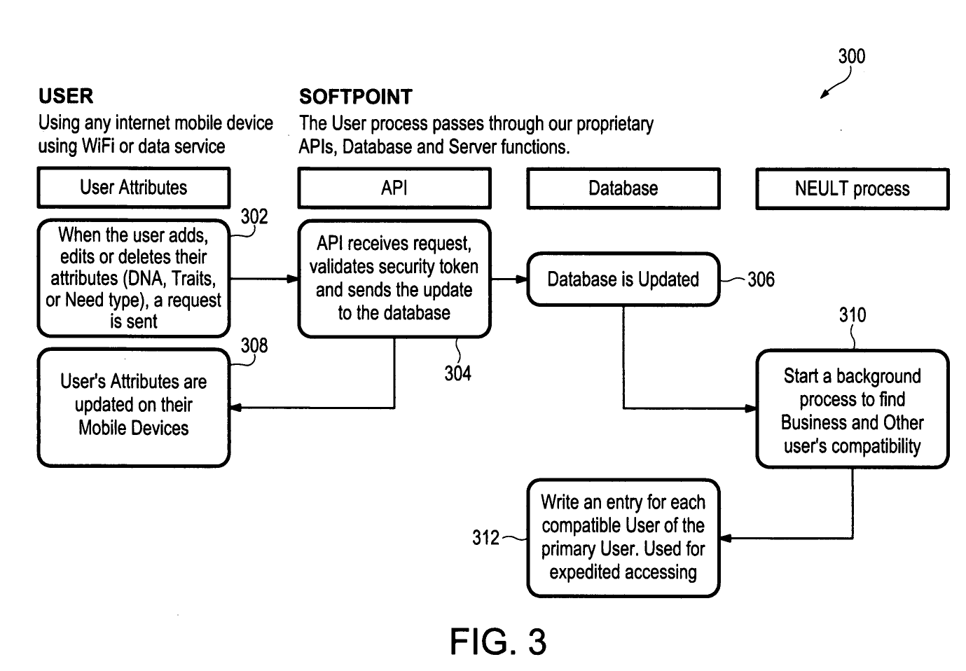

FIG. 3 is a process flow diagram illustrating a user add/edit attributes process that forms a part of the method in accordance with one embodiment of the invention. As may be seen, user add/edit attributes process 300 begins at 302 when the user adds, edits, or deletes his or her demographic attributes (e.g. immutable characteristics or so-called ‘DNA’, current likes, current dislikes, and/or current needs) and a signal is sent by user device 102a to API 110a. At 304, API 110a receives the request from user device 102a, validates the security token, and sends the update to database manager 106. At 306, database manager 106 updates the database in response to the updated data input by the user of user device 102a and sends an update command to the user device such that the user's demographic attribute data are updated at 308. Concurrently with the updating of database 108a at 306, respectively, database manager 106 at 310 sends a signal to server 104, which at 310 starts a background process to find businesses and/or other users that are compatible or in affinity with the user of user device 102a. Finally with respect to user add/edit attributes process 300, at 312 database manager 106 creates or writes an entry for each user that is determined to be compatible or in affinity with the user of user device 102a, the former being referred to here as one or more secondary users and the latter being referred to herein as the primary user.

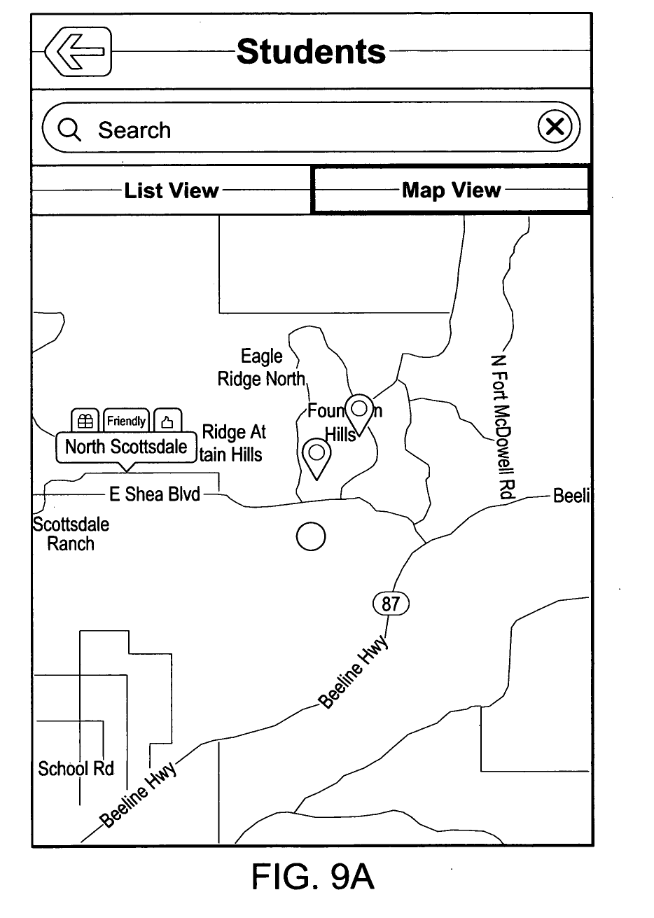

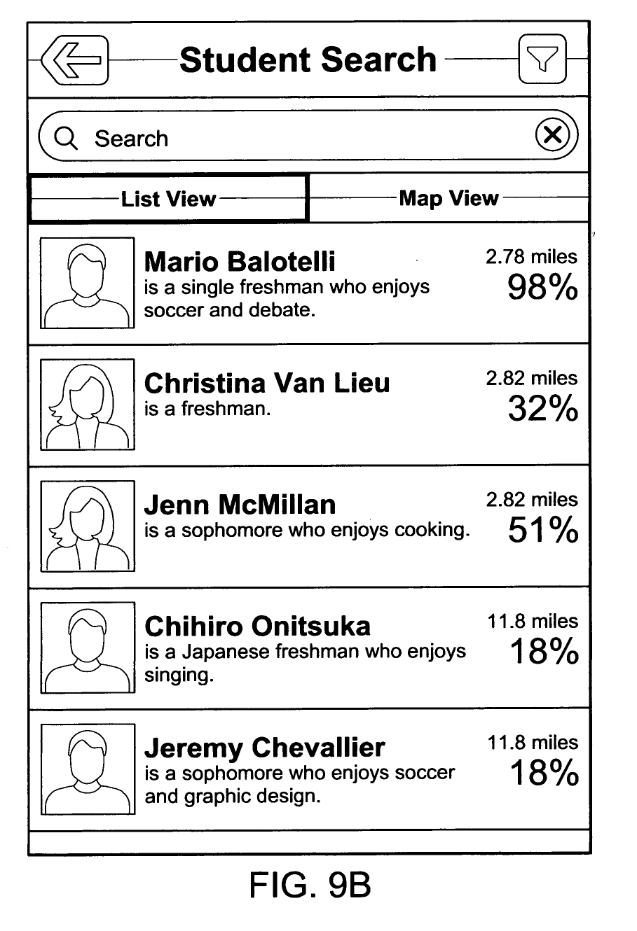

In accordance with one embodiment of the invention, there are three types of attributes a user can have, which are DNA (immutable, personal characteristics including race, sex, hair color, and the like), TRAIT (changeable, personal characteristics or preferences including school, hobbies, sports affiliations, languages spoken, and the like) and NEEDS (changeable, personal interests including recent web search subjects, a nearby shopping center or pizzeria, a colored pair of socks and the like). The user sets up his or her various attributes when registering/subscribing to or otherwise downloading and installing the app. Attributes can be added or deleted or temporarily or permanently suppressed (hidden) at anytime. The user's attributes are stored by the app in a database, and are compared in real time with stored attributes characterizing other users to bring two or more users together based upon similar attributes, as will be explained below by reference to FIGS. 9A and 9B. Those of skill in the art will appreciate that more or fewer types of attributes may be used to determine a level of affinity or compatibility between and among various users, within the spirit and scope of the invention.

In accordance with one embodiment of the invention, a series of server-based hardware- and software-implemented procedures and services are provided. These include negotiation as between or among various users and businesses including proximity and affinity, negotiation between or among various users and businesses in terms of filters any or all of whom and which might have in place to change their attributes and/or apparent availability in real time, commonality of attributes from a wider user perspective for up-to-date ranking thereof, and the handling in background mode of new information as it arrives at the server from various sources such as pings received from various users' mobile devices, updates to business databases, etc. This background processing of information is important to minimizing latency when an affinity and proximity determination must be made in real time by the server. Database management search keys are utilized, in accordance with one embodiment of the invention, to ensure that the greatest amount of the latest information is available for such real-time decision-making by the server.

Background so-called ‘number-crunching’ by the server acts to filter and thus to simplify and thus to speed up processing by, for example, ignoring users who are not signed into their accounts and thus ineligible to be notified of a proximity-affinity candidate, and/or ignoring users who are unavailable because they are in class or at work or otherwise occupied, etc. Thus, by crunching such numbers in a continuous, real-time process the decision-making data processing requirements are simplified and sped up to achieve truly real-time responses to last-minute changes of a user's or business's status, location, or attributes. Moreover, in accordance with one embodiment of the invention, proximity screening among users and businesses is performed first, thus eliminating a great amount of overhead and last-minute data processing. In other words, in a geographically diverse population of users and businesses, it likely would be determined during background data processing that an extremely high percentage (e.g. 99.999%) of the users and businesses are too geographically remote from a given primary user to require affinity data processing. Thus computing resources are made to focus on only an extremely small percentage (e.g. 0.001%) representing geographically proximate candidates for affinity checking This preliminary but ongoing decision-making or data-processing thus renders the real-time process of determining affinities much simpler and quicker and more responsive.

Those of skill will appreciate that, in accordance with another embodiment of the invention, the geographic proximity radius might be temporarily extended to analyze geographic proximity trends. For example, a primary and secondary user might be determined by geo-location in accordance with the invention to be 5.2 miles apart during execution of such a background process. In other words, the two users are just outside the default proximity threshold. A subsequent determination might show, however, that the two users' paths are convergent. Thus, such a trend analysis background process could anticipate that the two users' paths are likely to place them within the proximity threshold within a reasonable amount of time. Such background processing effectively anticipates and thus predicts the scenario in which the two users enter each other's proximity radius, and the process might then pre-screen the two potential candidates for affinity/compatibility. This and other trend analysis and predictive processing techniques are contemplated as being within the spirit and scope of the invention.

Those of skill in the art will appreciate that, in accordance with one embodiment of the invention, weighted averaging is used to determine the affinity or compatibility correlation as among the various DNA, likes, and needs criteria for each of the primary and the secondary registered owners or users. For example, a primary user might consider likes to be more important than either DNA or needs, and so such a user might give likes 50% weight and DNA and needs only 25% weight each. Also in accordance with one embodiment of the invention, weighted averaging is used to determine the affinity/compatibility and proximity contributions to the overall determination of whether, for example, to alert a primary user of a secondary user's affinity and proximity. For example, a primary user might consider affinity more important than proximity, and so might prefer that affinity be given 70% weight versus only 30% weight given to proximity, or vice versa. Such deviations from equally weighted averages that may be provided as default values by the app thus can be changed and individualized by use of settings entered on the registered owner's or user's filter screen (which is provided as a part of the mobile device's graphical user interface (GUI)).

In accordance with one embodiment of the invention, the attributes each receive an internal ranking This ranking is based on the popularity of the attribute. More frequently occurring or commonly listed attributes receive a higher ranking Then when users are matched by an attribute in common, the ranking of all of the attributes in common determines a percentage of commonality between two or more users. This determination is made by assessing the number of common attributes, adding a value representing the attributes' ranking, and then deducting a value representing other attributes that are not in common. The resulting number is then divided by the total number of variables (e.g. attributes plus ranking bonuses) to obtain a percentage of affinity or compatibility between 1% (lowest affinity/compatibility) and 100% (highest affinity/compatibility). Those of skill in the art will appreciate that such a ranking of common attributes is optional, and that other weighted-averaging techniques and considerations are contemplated as being within the spirit and scope of the invention.

Those of skill will also appreciate that a primary and a secondary user may have a different number of attributes in the attribute database. Nevertheless, the invented system, method and correlation engine calculates an affinity value for such each of such pair-wise user candidates. In other words, a primary user might have twenty-three attributes whereas a secondary user might have only six attributes. In accordance with one embodiment of the invention, the primary user's attributes valuation is normalized to 100% whereas the secondary user's attributes valuation is necessarily less than or equal thereto. Thus two-way user control is possible in accordance with one embodiment of the invention, by which is meant that a secondary user may be determined not to be sufficiently affinitive or compatible with the primary user, but nevertheless may choose to contact the primary user based upon a single attribute or relatively few attributes that the two have in common. It is ultimately up to the primary user in each pair-wise candidacy whether to answer or otherwise honor an attempted contact from the secondary user (and vice versa).

Accordingly, in accordance with one embodiment of the invention, there are two different user perspectives: Assume that user A lists two attributes and user B lists only one attribute. The one attribute listed by user B also appears as one of the attributes listed by user A. From user A's perspective a single attribute match with B's single listed attribute gives user A a 100% compatibility with user B despite the user A attribute that is not in user B's attribute list. From user A's perspective, user B's compatibility with user A is only 50% because of user B's single-mindedness (liking only one thing). From user B's perspective a single attribute match with one of user A's listed attributes gives user B a 100% compatibility with user A despite the user A attribute that is not in user B's attribute list. From user B's perspective, user A's compatibility with user B is only 50% because of user A's broad-mindedness (liking more than one thing). Those of skill in the art will appreciate, then, that as between any two users, each is primary from his or her own perspective but secondary from the other's perspective. Thus, user A might not contact user B because user B's affinity/compatibility is only 50% from user A's perspective whereas user B might contact user A because user A's affinity/compatibility is 100% from user B's perspective. Of course, it remains the prerogative of the person contacted to decline to respond to such a contact.

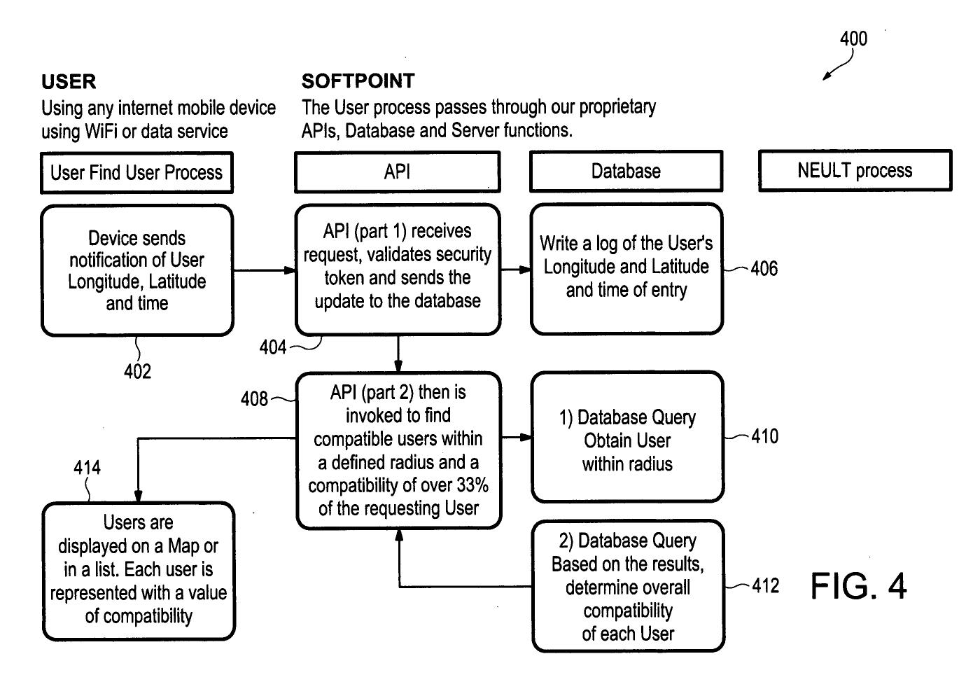

FIG. 4 is a process flow diagram illustrating a find-users part of the method including the geographic and demographic data-producing step in accordance with one embodiment of the invention. As may be seen, find users process 400 begins at 402 when user device 102a sends a notification of user longitude, latitude, and time, to API 102a. At 404, API 102a receives the request, validates the security token, and sends an update of current user position and time to database manager 106. Database manager 106 at step 406 responds to the update by creating or writing a log of the user's longitude and latitude and time of the user update entry in database 108a. At 408, and in response to the receipt by the first API of the update, a second API is invoked to find compatible or affinitive users who are within a defined radius, e.g. 8 kilometers (approximately five miles), of the primary user's user device 102a and who have a compatibility or affinity with the primary user that exceed a defined threshold, e.g. approximately 50%. Those of skill in the art will appreciate that the defined threshold is an established default value until and unless it is changed by the primary user. As will be seen, the defined default proximity and/or affinity values are readily changed by the user.

Thus, second API 110b may be seen to 1) send a database query to database manager 106 at 410 to obtain a user within the defined radius, and to 2) receive therefrom at 412 a determination of the overall compatibility of each user within the defined radius. Second API 110b then sends to user device 102a a list of users meeting the defined criteria for display in a graphic form, e.g. a map, or in a tabular form, e.g. a list, at 414. Each user who meets the defined criteria is represented by a compatibility or affinity value, e.g. as a percentage (%) wherein a higher % indicates a higher compatibility or affinity and wherein a lower % indicates a lower compatibility or affinity.

Those of skill will appreciate that first and second APIs 110a and 110b (API 1 and API 2, respectively) may be combined into a single, multi-purpose API or their functions may be segmented as illustrated in FIG. 1 for better performance. The APIs, which will be understood to be run through an application server, also perform many other smaller tasks, as will also be understood. Any alternative API arrangement is contemplated as being within the spirit and scope of the invention.

Those of skill in the art will appreciate that such a display on user device 102a enables the primary user to take an appropriate action, e.g. proceeding to meet one or more users who meet the defined criteria. Such proceeding is aided in accordance with the invention by the user device display, which shows the location of the one or more secondary users in spatial and directional relationship with the primary user. Indeed, a smart phone equipped with a SIRI-like vocal digital assistant might even direct the primary user toward the secondary user (and/or vice versa) in real-time (‘on-the-fly’) response to the continuously changing location of either or both users.

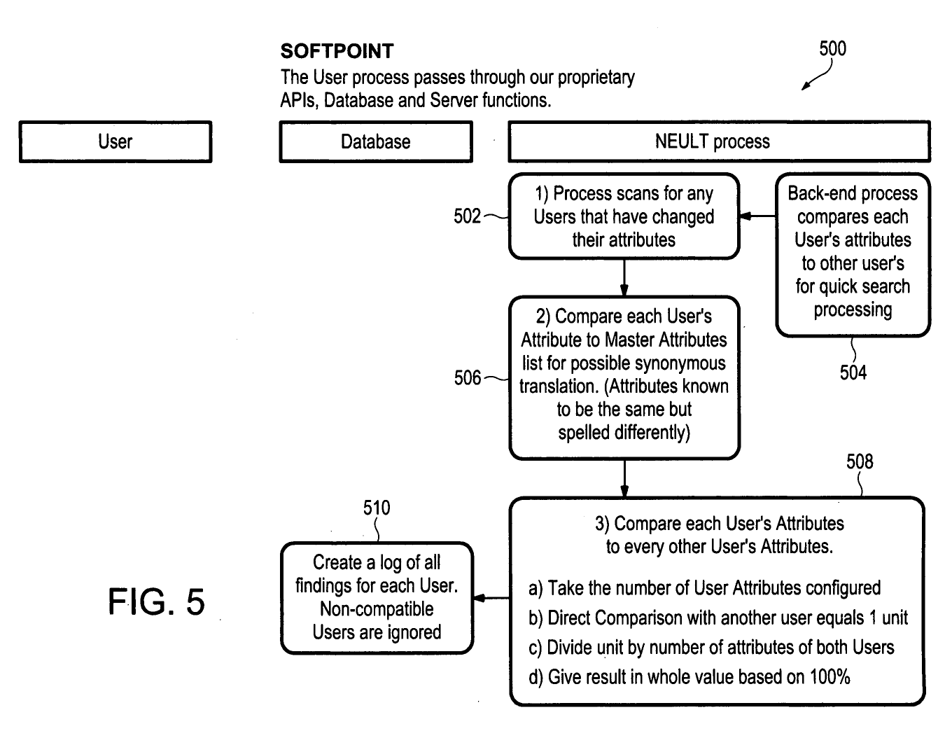

FIG. 5 is a process flow diagram illustrating a user-compatibility part of the method including the geographic and demographic weighted averaging- and correlation index-producing step in accordance with one embodiment of the invention. The process 500 may be seen to include a step at 502 to scan for any users who have changed their attributes, and a step at 504 that involves a back-end process that compares each user's attributes to other users' attributes for quick search processing. Process 500 further includes a step at 506 to compare each user's attribute to a master attributes list for possible synonymous translation of attributes that are determinable to be the same but that are spelled differently, in what will be referred to herein as a digital thesaurus. Process 500 further includes at step at 508 to compare each user's attributes to every other users' attributes. This step includes the sub-steps of a) taking the number of user attributes that are configured, b) performing a direct comparison with another user to produce one unit for each direct comparison, c) dividing the total number of units by the total number of attributes of both users, and d) producing a result in a whole value based on 100%. Finally, process 500 includes a step at 510 of creating a log of all findings for each user, wherein non-compatible users are ignored.

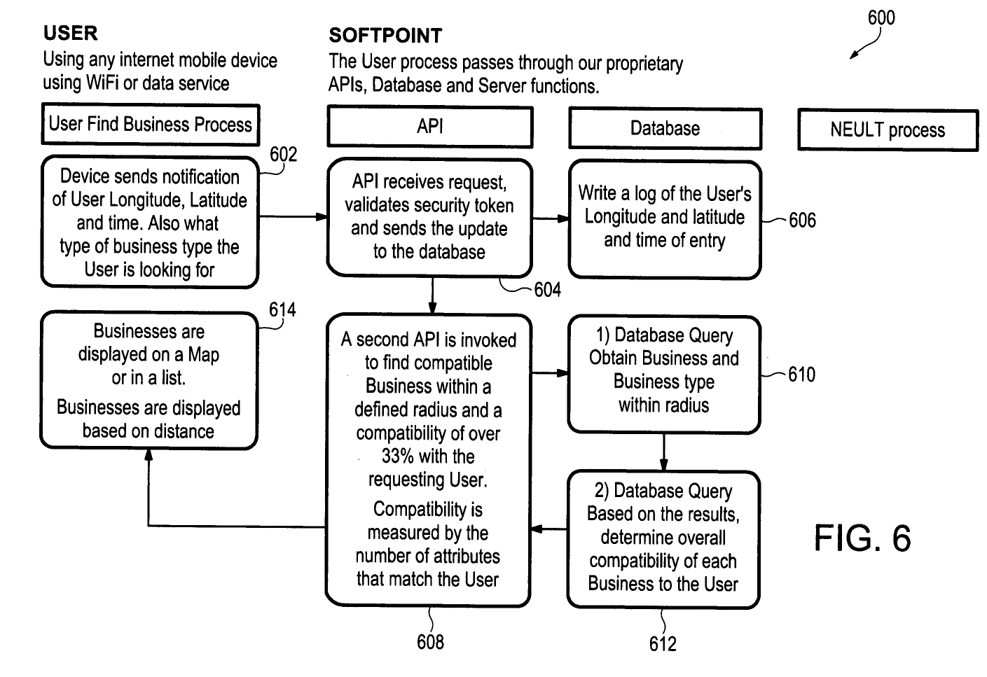

FIG. 6 is a process flow diagram illustrating a find-business part of the method in accordance with another embodiment of the invention. Process 600 includes the mobile device sending a notification of user longitude, latitude, time, and for which type of business the user is looking at 602. Process 600 further includes at 604 API 1 receiving the notification/request, validating the attached security token, and sending the update to the database. It further includes at 606 writing a log of the user's longitude, latitude, and time of entry to the database. Concurrently, API 2 is invoked to find one or more compatible businesses within a defined radius of and with a compatibility of over 33% (or other suitable default value) with the requesting user's business type or preference. Compatibility is measured, for example, by the number of attributes of the business that match the user's specified attributes. Alternative compatibility measurement criteria are contemplated as being within the spirit and scope of the invention.

Step 608 in accordance with one embodiment of the invention is performed at step 610, wherein a database query is conducted to obtain business and business type information within the radius and at step 612, wherein from the database query results, the overall compatibility of each databased business within the specified radius relative to the user's preferences is determined. Finally, at 614 a list including the name and address of one or more businesses that are within the radius and deemed compatible are displayed on the user' mobile device in either a map or list view that informs the user of both the compatibility and proximity of the mapped or listed business meeting the user's affinity and proximity criteria.

FIG. 7 is a system block diagram of the system, in accordance with another embodiment of the invention. Those of skill will see that system 700 includes an affinity mechanism 702 and a proximity mechanism 704 that feed a monitor & control mechanism 706. Monitor & control mechanism 706 controls a GPS-capable user device 708 that may be the take the form of primary or secondary user device 102a or 102b of FIG. 1. User device 708 will be understood to yield demographic data that is fed to affinity mechanism 702 and also to yield geo-location data that is fed to proximity mechanism 704. Thus a real-time monitor and control of a user's mobile device is provided by the invented system, as described and illustrated herein.

FIG. 8 is a schematic block diagram of an affinity-and-proximity correlation engine, in accordance with one embodiment of the invention. As may be seen, correlation engine 800 includes a proximity monitor 802, an affinity monitor 804, and a correlative data processor/special-purpose computer 806. Proximity data from proximity monitor 802 feeds real-time proximity data (e.g. geo-location data for a primary and a secondary user) to correlative data processor 806 while affinity data from affinity monitor 804 feeds real-time affinity data (e.g. immutable characteristics (“DNA”), current likes (“LIKES”), current dislikes (“DISLIKES”, which those of skill in the art will appreciate as being capable of being accommodated by discounting or subtracting a value from the value of LIKES—in other words, DISLIKES can be treated for computational purposes as negative LIKES), and/or current needs (NEEDS), etc. for the primary and the secondary user) to correlative data processor 806. Correlative data processor 806 analyzes the correlation between the primary and secondary user's proximity and affinity and produces what will be referred to herein as a correlation index representative of the level of both proximity and affinity between the primary and secondary users. As described and illustrated herein, the correlation index may be represented by a percentage or in accordance with any alternative value or unit or unit-less ratio.

Use Case Example

FIGS. 9A and 9B are graphic illustrations representing screen grabs from the user device that inform the user of one or more businesses and/or one or more other users' proximity and compatibility or affinity with the primary user in alternatively graphic (map) and/or tabular (list) form, respectively. As may be seen, FIG. 9A is a map view representing part of the user device interface in accordance with one embodiment of the invention in which students are enabled to locate other students that are both proximate and compatible. Those of skill in the art will appreciate that the circular icon represents a first user of the user device whereas the upside-down teardrop icons represent other users that are both proximate and compatible with the first user. The background is a map of the area around the first user, and includes topological and other features like any map.

The map view shown in FIG. 9A also identifies the location of a nearby italian restaurant, with an overlay business icon in North Scottsdale, Ariz. This business icon appears on the user device display because the first user has indicated a preference for Italian food, and because the Italian restaurant is within a defined proximity of the first user. So, once again, both proximity and compatibility are considered by the invented system to be important parameters for monitoring the first user's whereabouts relative to other users and businesses and also the first user's preferences or affinities. If the first user touches his or her finger on one or both of the teardrop icons, the other users' personal information will be displayed briefly in the display near the icon representing the other person.

FIG. 9B shows an alternative display mode in which the same information that is shown in FIG. 9A in map view is shown instead in list view. It appears that Mario is the closest compatible user at a proximity of 2.78 miles, while Jenn is one of the next closest (but somewhat less compatible than Mario) user at a proximity of 2.82 miles. Thus, it will be appreciated that Mario and Jenn are represented by the upside-down teardrop icons in FIG. 9A. The other users shown in the list view of FIG. 9B are less compatible than either Mario or Jenn, and generally are also more distant. This is why they have been filtered out of the map view of FIG. 9A by an active software filter technique in accordance with one embodiment of the invention. Thus, in map view, only those other users or businesses that meet the combined proximity and compatibility or affinity threshold are represented icono-graphically. This avoids a potentially cluttered and confusing display screen.

As may be seen from FIG. 9B, the list view shows fellow subscribed students who are compatible on some level and their proximity to the first user as well as the extent of their compatibility therewith. It also shows some personal attributes of the various subscribed users. Those of skill in the art will appreciate that the default, generic male/female avatars in the list view of FIG. 9B may be replaced by photos or other representations by which the various subscribed students may desire to be seen and known. The first user's photo or other representation similarly may appear on the other subscribed students' user devices when the other user devices are in list view. This social networking feature of the invention creates a better familiarity among subscribed students with the ability to recall at a glance who the student is and some pertinent information about the student.

Those of skill in the art will appreciate that the student application is but one of many that are enabled by the present invention. Other applications such as an (Italian) travel application or a (2016 Rio Olympic) event application may be implemented in keeping with the teachings herein, but the user interface may be somewhat different to accommodate different applications. For example, a 2016 Rio Summer Olympic attendee who speaks no Portuguese might use the invention to find fellow attendees who are also fluent in English. In a crowded stadium, this might be otherwise difficult or impossible without the invented proximity-affinity monitor. Indeed, geo-location is now so accurate that an app based upon the present invention might even pinpoint the other attendee's Olympic stadium section, row, and seat number for the first user.

It will be understood that the user of mobile device 10 via a touch-screen-display-based graphic user interface (GUI) is able in accordance with one embodiment of the invention to become ‘invisible’ to others, to change his or her personal attributes, to edit his or her proximity and affinity thresholds, etc. from their default values. This can be done in real time by the user. For example, this can be done by the user speaking commands to a SIRI-like voice recognition software mechanism residing in the mobile device or by the more tactile user simply selecting a filter screen on the GUI and either typing or pointing-and-dragging or pinching or spreading two fingers (analogous to a known zoom-out or zoom-in technique) on a perimeter of a feature (e.g. on a proximity radius on a map or affinity threshold edge of a pie slice on a pie chart). Such a real-time input to the mobile device acts to change the default setting that is programmed into the invented proximity-affinity-based monitoring and control app. Alternative and/or additional filters and GUI features are contemplated as being within the spirit and scope of the invention.

Those of skill in the art will appreciate that the software architecture and methodologies described and illustrated herein can be implemented in any suitable code by the use of any suitable coding and language tools. For example, any one or more of Python, Java, C#, C++, HTML, XML, and MySQL are a suitable suite of tools for coding the invented system, method, and correlation engine.

It will also be understood that the present invention is not limited to the method or detail of construction, fabrication, material, application or use described and illustrated herein. Indeed, any suitable variation of fabrication, use, or application is contemplated as an alternative embodiment, and thus is within the spirit and scope, of the invention.

It is further intended that any other embodiments of the present invention that result from any changes in application or method of use or operation, configuration, method of manufacture, shape, size, or material, which are not specified within the detailed written description or illustrations contained herein yet would be understood by one skilled in the art, are within the scope of the present invention.

Finally, those of skill in the art will appreciate that the invented method, system and apparatus described and illustrated herein may be implemented in software, firmware or hardware, or any suitable combination thereof. Preferably, the method system and apparatus are implemented in a combination of the three, for purposes of low cost and flexibility. Thus, those of skill in the art will appreciate that embodiments of the methods and system of the invention may be implemented by a general-purpose computer or microprocessor in which purposive instructions are executed, the purposive instructions being stored for execution on a computer-readable medium and being executed by any suitable instruction processor that, in operation, acts as a special-purpose machine performing a special-purpose process.

Accordingly, while the present invention has been shown and described with reference to the foregoing embodiments of the invented apparatus, it will be apparent to those skilled in the art that other changes in form and detail may be made therein without departing from the spirit and scope of the invention as defined in the appended claims.

We claim:

1. A real-time mobile device monitoring and control system comprising:
two or more mobile devices configured to run application software, the software configured to enable each of the two or more devices in real time to communicate their respective geo-location data to a web-based server;
a database configured to affiliate the two or more mobile devices with their respective registered owners, the database storing the two or more registered owners' names and real-time geo-location data, the database further storing the two or more registered owners' demographic data including personal attributes, the demographic data capable of being updated in real time by a web-based server; and
a web-based server configured to respond periodically to demographic and geographic information about the two or more registered owners of the two or more mobile devices by storing the same in the database in real time.

2. The system of claim 1, wherein the attributes are capable of being updated in real-time response to input from one or more of the two or more registered owners.

3. The system of claim 1, wherein the attributes include one or more of immutable characteristics, current likes, current dislikes, and current needs.

4. The system of claim 1 further comprising:
an affinity mechanism for determining in real time as between the two or more registered owners a degree of correlation between the two or more registered owners' contemporaneous demographic data.

5. The system of claim 1 further comprising:
a proximity mechanism for determining in real time as between the two or more registered owners a degree of correlation between the two or more registered owners' contemporaneous geo-location data.

6. The system of claim 1 further comprising:
an affinity mechanism configured to determine in real time as between the two or more registered owners a degree of correlation between the two or more registered owners' contemporaneous demographic data;
a proximity mechanism configured to determine in real time as between the two or more registered owners a degree of correlation between the two or more registered owners' contemporaneous geo-location data; and
a control mechanism coupled with the affinity and the proximity mechanisms, the control mechanism configured in real time to combine the degrees of correlation between the two or more registered owners' contemporaneous demographic and geo-location data to produce an affinity-proximity correlation index and in real time to inform one or more of the two or more registered owners if the correlation index is above a defined threshold.

7. The system of claim 6, wherein at least the affinity, proximity, and control mechanisms include a processor configured to execute instructions stored in a memory.

8. The system of claim 7, wherein the demographic data are configured to be updated in real-time response to any one or more of the two or more registered owners' inputs.

9. The system of claim 8, wherein the control mechanism is configured to establish the affinity-proximity correlation index based at least in part on default threshold that is capable of being modified in real time by one or more of the two or more registered owners.

10. The system of claim 1 further comprising:
an affinity-proximity mechanism configured to determine in real time as between one or more of the two or more registered owners and a registered business a degree of correlation between the one or more of the two or more registered owners and the registered business's contemporaneous demographic and geo-location data,
the web-based server further configured to respond periodically to the contemporaneous demographic and geo-location data about the one or more of the two or more registered owners and the registered business by storing the same in the database in real time.

11. A real-time mobile device monitoring and control method comprising:
determining in real time as between two or more registered owner's of mobile devices a degree of correlation between the two or more registered owners' contemporaneous demographic data;
determining in real time as between the two or more registered owners a degree of correlation between the two or more registered owners contemporaneous geo-location data;
combining in real time the degrees of correlation between the two or more registered owners' contemporaneous demographic and geo-location data to produce an affinity-proximity correlation index; and
informing in rel time one or more of the two or more registered owners if the correlation index is above a defined threshold.

12. The method of claim 11, wherein both determining steps, the combining step, and the informing step are performed by a processor configured to execute instructions stored in a memory.

13. The method of claim 12, wherein the informing is performed by displaying on one or more of the two or more registered owners a screen including at least one or a map view and a list view identifying at least another registered owner's demographic data, the geo-location data, and the correlation index.

14. A correlation engine for use in connection with web-based mobile device monitoring and control, the engine comprising:
a proximity monitor for monitoring the proximity between two or more web-based mobile device users, and
an affinity monitor for monitoring the affinity between the two or more web-based mobile device users,
wherein the proximity monitor and the affinity monitor are configured to operate concurrently and in real time to produce a proximity-affinity correlation index based at least in part on the proximity and affinity of the two or more such web-based mobile device users.

15. The engine of claim 14, wherein the proximity monitor is further configured in real time to produce a proximity correlation index indicative at least in part of a weighted average of individualized and databased attributes associated with a first of the two or more web-based mobile device users, wherein the affinity monitor is configured to produce an affinity correlation index indicative at least in part of a weighted average of databased individualized attributes associated with a second of the two or more web-based mobile device users, and wherein the proximity-affinity correlation index is based at least in part on the proximity correlation index and at least in part on the affinity correlation index.

16. The engine of claim 14, wherein the attributes are capable of being updated in real-time response to input from one or more of the two or more web-based mobile device users.

17. The engine of claim 14, wherein the attributes include two or more of immutable characteristics, current likes, current dislikes, and current needs.

18. The engine of claim 17, wherein the affinity monitor monitors the affinity by producing a defined weighted average of the one or more attributes.

19. The engine of claim 14, wherein the demographic data are configured to be updated in real-time response to any two or more web-based mobile device users' inputs.

20. A real-time mobile device monitoring and control system comprising:
the correlation engine of claim 14;
two or more mobile devices each owned by a user and each including a graphic display;
a database; and
a web-based server configured to respond to demographic and geo-location data about each user of the two or more web-based mobile devices by storing the same in the database,
wherein the correlation engine and the server operatively collectively are configured to monitor and store the two or more mobile devices' real-time proximity, to monitor and store each users' real-time affinity, and to control each of the two or more mobile devices by displaying real-time proximity and affinity data on the graphic display thereof.
